(19) United States
(12) Patent Application Publication
(10) Pub. No.: US 2019/0182301 A1
(43) Pub. Date: Jun. 13, 2019

(54) Method of Presenting a Desired Multimedia Object Using a Multimedia Presentation Device via Operation of a Mobile User Device

(71) Applicants: Yi-Chih Lu, Taipei City (TW); Bravo Ideas Digital Co., Ltd., Tortola (VG)

(72) Inventor: Yi-Chih Lu, Taipei City (TW)

(21) Appl. No.: 15/989,333

(22) Filed: May 25, 2018

(30) Foreign Application Priority Data
Dec. 7, 2017 (TW) 106142926

(51) Int. Cl. H04L 29/06; G06F 3/14; H04N 21/6437

(52) U.S. Cl. CPC H04L 65/4076; H04N 21/6437; H04L 29/06027; G06F 3/1454

(57) ABSTRACT

A method of presenting a desired multimedia object using a multimedia presentation end device via operation of a mobile end device is proposed to include: (A) receiving, by a server end device from the mobile end device, a target identification data piece that relates to the multimedia presentation end device, and a target object data piece that relates to the desired multimedia object; and (B) generating, by the server end device based on the target object data piece, desired multimedia object data that relates to the desired multimedia object and that is configured to cause the multimedia presentation end device to present the desired multimedia object, and transmitting the desired multimedia object data to the multimedia presentation end device based on the target identification data piece.

### CROSS-REFERENCE TO RELATED APPLICATION

This application claims priority of Taiwanese Invention Patent Application No. 106142926, filed on Dec. 7, 2017.

### FIELD

The disclosure relates to a method of presenting a multimedia object, and more particularly to a method of presenting a multimedia object using a multimedia presentation end device via operation at a mobile end.

### BACKGROUND

Mobile devices, such as smartphones, tablet computers, notebook computers, etc., are widely used in daily life due to their portability. However, the relatively small screen of the mobile devices may not be satisfactory when a user wishes to present information in the mobile devices to other people or to enjoy a good viewing experience.

To solve this problem, nowadays, the user may use a streaming media player, such as Chromecast, Miracast, Airplay, to transmit data from the mobile device to a display device with a larger screen for presentation thereon. Nonetheless, such implementation requires that the mobile device be within a certain distance range depending on the technology used for data transmission (e.g., Wi-Fi) for pairing with the streaming media player that is connected to the display device. After the complicated pairing operation, the user can finally transmit data in the mobile device to the display device for presentation thereon.

### SUMMARY

Therefore, an object of the disclosure is to provide a method of presenting a desired multimedia object using a multimedia presentation end device via operation at a mobile end, and the method can alleviate limitation in terms of distance and the inconvenience resulting from the complicated pairing operation which may occur in the conventional technology.

According to the disclosure, the method is implemented by a system that includes a server end device communicatively connected to the multimedia presentation end device and the mobile end device via a first communication network. The method includes steps of: (A) receiving, by the server end device from the mobile end device via the first communication network, a target identification data piece that relates to the multimedia presentation end device, and a target object data piece that relates to the desired multimedia object; and (B) generating, by the server end device based on the target object data piece, desired multimedia object data that relates to the desired multimedia object, and transmitting, by the server end device based on the target identification data piece, the desired multimedia object data to the multimedia presentation end device via the first communication network. The desired multimedia object data causes the multimedia presentation end device to present the desired multimedia object.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a system to implement a first embodiment of the method of presenting a desire multimedia object using a multimedia presentation end device according to the disclosure;

FIG. 2 is a flow chart illustrating steps of the first embodiment;

FIG. 3 is a schematic diagram exemplarily illustrating that a multimedia presentation end device presents a desired multimedia object by use of the embodiments according to this disclosure;

FIG. 4 is a block diagram illustrating a system to implement a second embodiment of the method of presenting a desire multimedia object using a multimedia presentation end device according to the disclosure;

FIG. 5 is a flowchart illustrating steps of the second embodiment; and

FIG. 6 is a schematic diagram showing an exemplary implementation of this embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

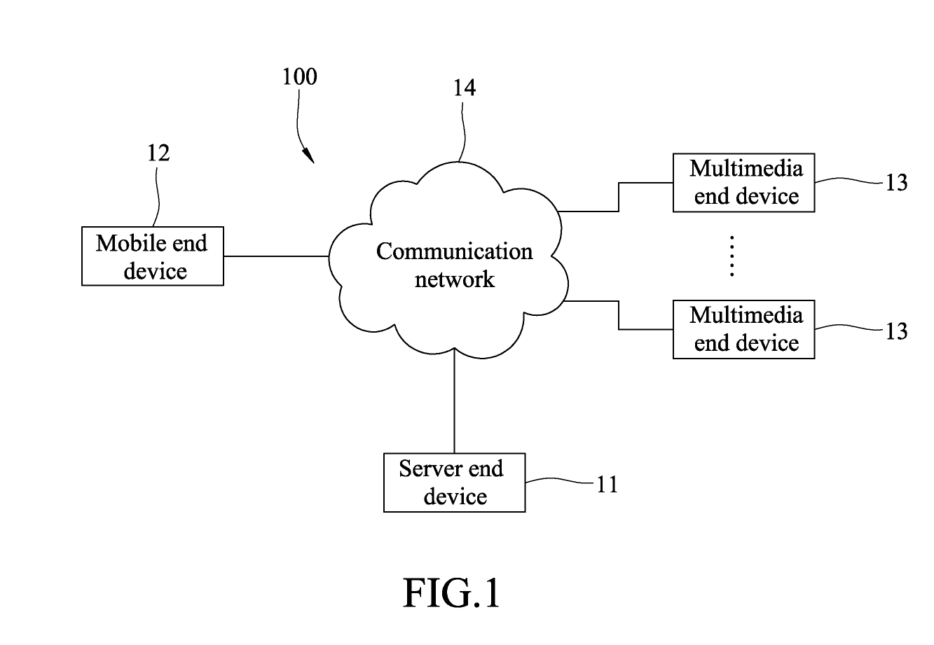

Referring to FIG. 1, the first embodiment of the method of presenting a desire multimedia object using a multimedia presentation end device according to this disclosure is implemented by a system 100 that includes a server end device 11, a mobile end device 12, and a plurality of multimedia end devices 13, where the multimedia presentation end device is one of the multimedia end devices 13 which is selected by a user of the mobile end device 12.

The server end device 11 is communicatively connected to the multimedia end devices 13 and the mobile end device 12 via a communication network 14, and stores a plurality of multimedia end position data pieces, a plurality of identification data pieces, a plurality of multimedia objects and a plurality of object codes that respectively correspond to the multimedia objects. Each of the multimedia end position data pieces relates to a geographic position of a respective one of the multimedia end devices 13. Each of the identification data pieces corresponds to a respective one of the multimedia end position data pieces, and includes a network address data piece relating to the multimedia end device 13 to which the respective multimedia end position data piece corresponds (which may hereinafter be referred to as the corresponding multimedia end device 13 of the network address data piece, and thus also of the identification data piece).

In this embodiment, the communication network 14 is exemplified to be the Internet, and each network address data piece contains an Internet protocol (IP) address relating to the corresponding multimedia end device 13. In other embodiments, the communication network 14 may be Ethernet, and each network address data piece may contain a media access control (MAC) address relating to the corresponding multimedia end device 13. Each multimedia object may be a video object, an image object, a document object, an audio object, etc.

The mobile end device 12 may be, for example, a smartphone, a tablet computer, etc., and each multimedia end device may be a display device that is capable of connection to the communication network 14.

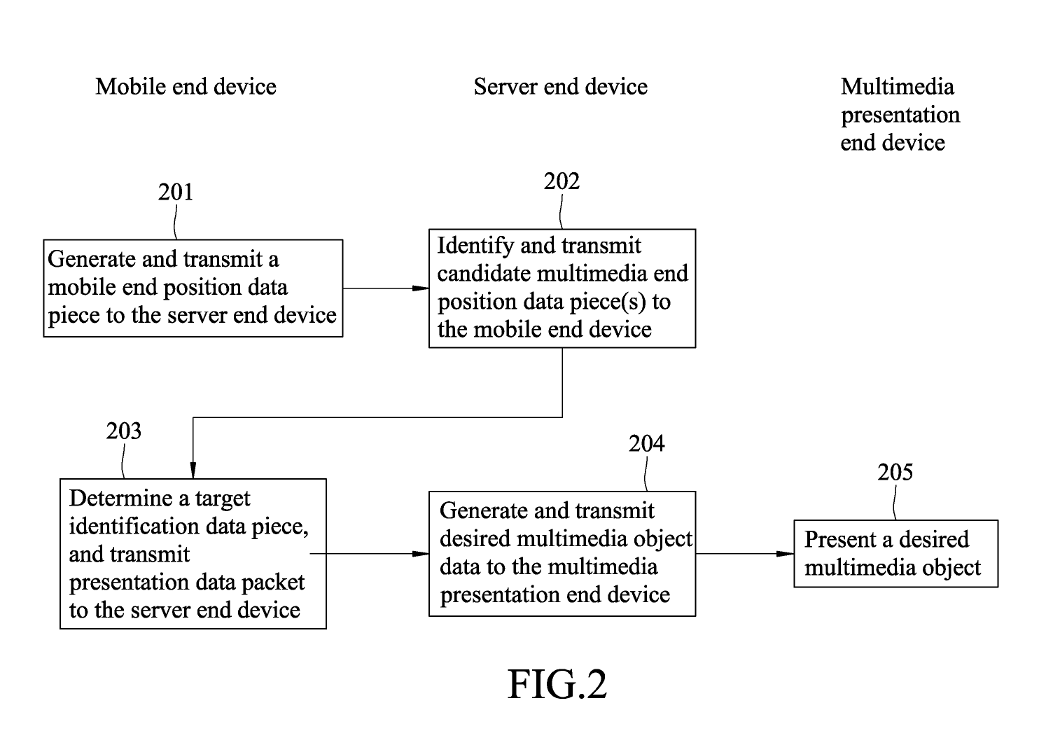

Referring to FIGS. 1 and 2, the first embodiment is exemplified to include steps 201 through 205.

In step 201, the mobile end device 12 generates a mobile end position data piece relating to a geographic position of the mobile end device 12 via, for example, a global positioning system (GPS) device thereof, and transmits the mobile end position data piece to the server end device 11 via the communication network 14.

In step 202, upon receipt of the mobile end position data piece via the communication network 14, the server end device 11 identifies, from the multimedia end position data pieces and based on the mobile end position data piece, at least one candidate multimedia end position data piece that corresponds to at least one of the multimedia end devices 13 of which the geographic position is within a predetermined positional range in relation to the mobile end device 12, and acquires at least one candidate identification data piece that corresponds to the at least one candidate multimedia end position data piece from the identification data pieces. Then, the server end device 11 transmits the at least one candidate multimedia end position data piece and the at least one candidate identification data pieces to the mobile end device 12 via the communication network 14. Hereinafter, it is assumed that the server end device 11 identifies multiple candidate multimedia end position data pieces for ease of explanation, but this disclosure is not limited in this respect. In this embodiment, each geographic position (for either the mobile end device 12 or any of the multimedia end devices 13) is represented using GPS coordinates, and the predetermined positional range is exemplified to be 10 meters (i.e., the multimedia end device(s) 13 whose GPS coordinates included in the corresponding multimedia end position data piece are within a 10-meter radius from the mobile end device 12 would be identified as a candidate multimedia end device 13 to be used for presenting the desired multimedia object). In practice, the mobile end device 12 may be used to play a video, to execute an application (e.g., a gaming application), or to display a document prior to step 201 or between steps 201 and 202.

In step 203, upon receipt of the candidate identification data pieces via the communication network 14, the mobile end device 12 acquires a target identification data piece from the candidate identification data pieces in response to a select operation by the user, and acquires a target object data piece (target object code), which is one of the object codes and which corresponds to the desire multimedia object, in response to input operation by the user. Then, the mobile end device 12 transmits a presentation data packet containing the target identification data piece and the target object data piece to the server end device 11 in response to a trigger operation by the user. In practice, the user operates the mobile end device 12 to select one of the candidate identification data pieces to serve as the target identification data piece, and to manually input one of the object codes that corresponds to a desired one of the multimedia objects to serve as the target object data piece. It is noted that the multimedia end device 13 which corresponds to the target identification data piece is the multimedia presentation end device, which is selected by the user to present the desired multimedia object. In this embodiment, the trigger operation may be a finger swiping through a touch screen of the mobile end device 12, a swinging motion of the mobile end device 12, etc., and this disclosure is not limited in this respect.

In step 204, upon receipt of the presentation data packet via the communication network 14, the server end device 11 compares the target object code with the object codes stored therein to determine the desired multimedia object that corresponds to the target object code, so as to generates desired multimedia object data that relates to the desired multimedia object and that will cause the multimedia presentation end device to present the desired multimedia object. Then, the server end device 11 transmits the desired multimedia object data to the multimedia presentation end device via the communication network 14 based on the network address data piece included in the target identification data piece.

In step 205, upon receipt of the desired multimedia object data, the multimedia presentation end device presents the desired multimedia object.

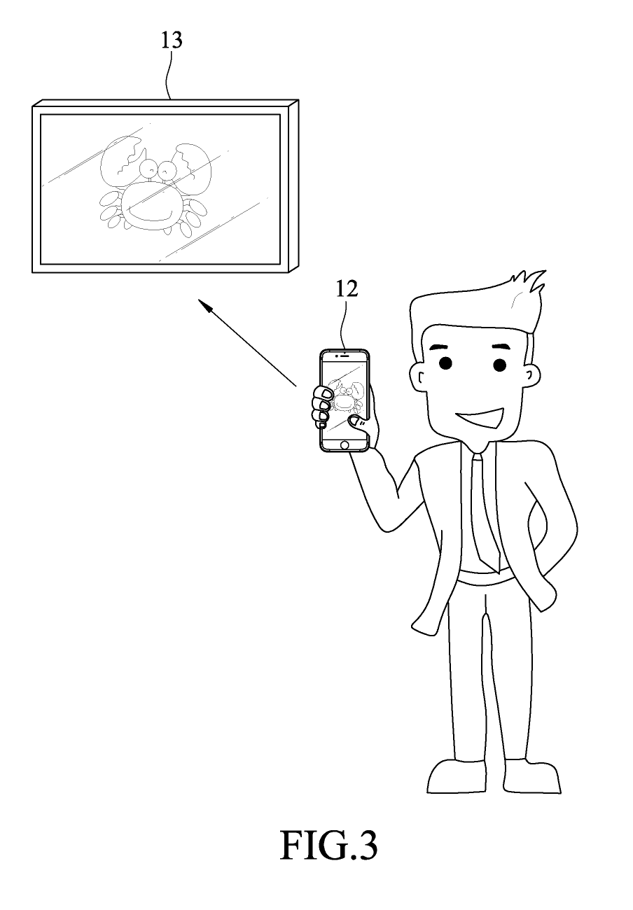

For example, when the user is in the vicinity of a mass rapid transit (MRT) station, and the mobile end device 12 transmits the mobile end position data piece to the server end device 11, the server end device 11 may determine, based on the mobile end position data piece and the multimedia end position data pieces, that a first multimedia end device near exit four of the MRT station, a second multimedia end device near exit five of the MRT station, and a third multimedia end device near exit six of the MRT station are located within the predetermined positional range in relation to the mobile end device 12. Then, the server end device 11 transmits the (candidate) multimedia end position data pieces corresponding to the first, second and third multimedia end devices and the corresponding (candidate) identification data pieces to the mobile end device 12. If the user wishes to present the desired multimedia object using the second multimedia end device which is near exit five, the user may operate the mobile end device 12 to select the (candidate) identification data piece corresponding to the second multimedia end device to be the target identification data piece (i.e., selecting the second multimedia end device to be the multimedia presentation end device). Then, the mobile end device may display object images such as a tiger pattern image, a lion pattern image, a crocodile pattern image, a panther pattern image, a crab pattern image, etc., each corresponding to one of the object codes. Referring to FIG. 3, the user may operate the mobile end device 12 to select the crab pattern image to acquire the corresponding object code, or to directly input the object code corresponding to the crab pattern image to serve as the target object code. Then, the user may perform the trigger operation (e.g., finger swiping through the screen of the mobile end device 12 or swinging the mobile end device 12), triggering the mobile end device 12 to transmit the presentation data packet containing the target identification data piece and the target object data piece to the server end device 11. Subsequently, the server end device 11 may compare the received target object code and the object codes stored therein to identify the desired multimedia object, so as to generate the desired multimedia object data which is transmitted to the second multimedia end device (multimedia presentation end device) based on the received target identification data piece. Upon receipt of the desired multimedia object data, the second multimedia end device may display, for example, a motion image that shows a moving crab.

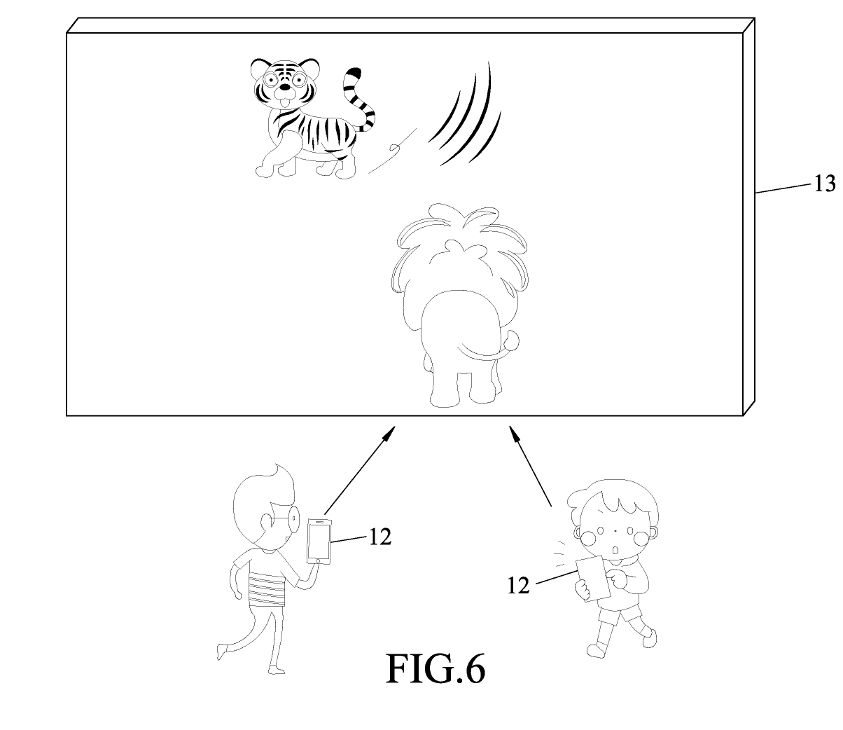

It should be noted that, in other embodiments, the server end device 11 may receive multiple presentation data packets that contain the same target identification data piece from different mobile end devices 12 at the same time, and generate a plurality pieces of the desired multimedia object data which respectively correspond to the presentation data packets and which are subsequently submitted to the same multimedia (presentation) end device that correspond to the target identification data piece, so that the multimedia presentation end device presents the desired multimedia objects (which may be different for different mobile end devices 12) at the same time. For instance, a desired multimedia object for a mobile end device 12 may be a motion image showing an attacking action of a lion, and a desired multimedia object for another mobile end device 12 may be a motion image showing a dodging action of a tiger, as depicted in FIG. 6. As a result, different mobile end devices 12 may interact with each other via the same multimedia (presentation) end device 13.

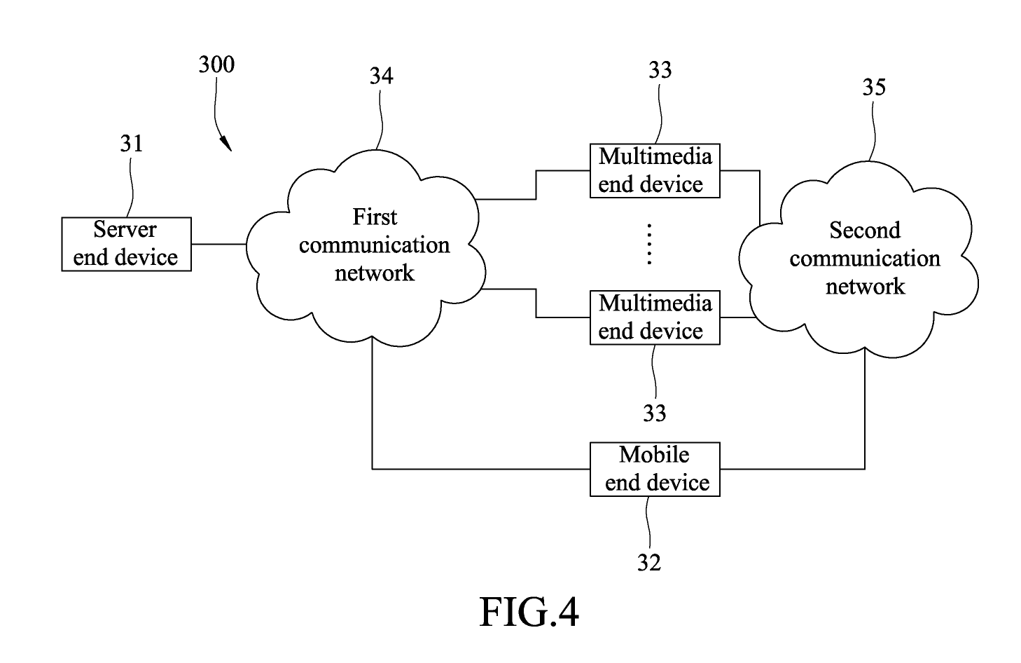

Referring to FIG. 4, a second embodiment of the method of presenting a desire multimedia object with a multimedia presentation end device according to this disclosure is implemented by a system 300 that includes a server end device 31, a mobile end device 32, and a plurality of multimedia end devices 33, where the multimedia presentation end device is one of the multimedia end devices 33 which is selected by a user of the mobile end device 32.

The server end device 31 is communicatively connected to the multimedia end devices 33 and the mobile end device 32 via a first communication network 34, and stores a plurality of network address data pieces, and a plurality of identification data pieces. Each of the identification data pieces corresponds to a respective one of the multimedia end devices 33. Each of the network address data pieces correspond to a respective one of the identification data pieces. In this embodiment, each network address data piece includes an IP address relating to one of the multimedia end devices 33 to which the corresponding identification data piece corresponds, and each identification data piece includes a device identification code relating to the corresponding multimedia end device 33. In this embodiment, the mobile end device 32 stores therein a plurality of multimedia objects, and each of the multimedia end devices 33 contains one of the identification data pieces that corresponds to itself.

Each of the mobile end device 32 and the multimedia end devices 33 is connected to a second communication network 35. In this embodiment, the first communication network 34 is exemplified to be the Internet, and the second communication network 35 is a short-range wireless communication network, such as a Bluetooth network.

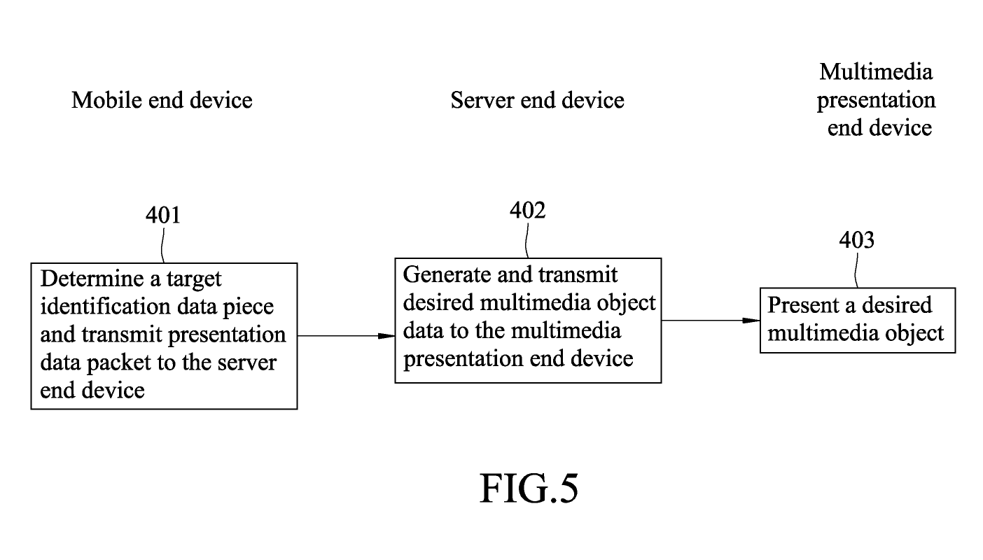

Referring to FIGS. 4 and 5, the second embodiment is exemplified to include steps 401 through 403.

When the mobile end device 32 receives at least one identification data piece and a corresponding device name from at least one of the multimedia end devices 33 via the second communication network 35, the flow goes to step 401. Hereinafter, it is assumed that the mobile end device 32 receives multiple identification data pieces and corresponding device names for ease of explanation. In step 401, the mobile end device 32 selects one of the identification data pieces to serve as a target identification data piece in response to a select operation by the user, and transmits a presentation data packet that contains the target identification data piece, and a target object data piece which contains the desired multimedia object selected by the user from the multimedia objects, to the server end device 31 via the first communication network 34. In this step, the user may operate the mobile end device 32 to select the target identification data piece from the received identification data pieces based on the device names.

In step 402, upon receipt of the presentation data packet via the first communication network 34, the server end device 31 generates desired multimedia object data containing the desired multimedia object based on the target object data piece, and acquires a target address data piece from the network address data pieces based on the device identification code included in the target identification data piece and a lookup table that records correspondences between device identification codes and network address data pieces. Then, the server end device 31 transmits the desired multimedia object data to the multimedia presentation end device via the first communication network 34 based on the target address data piece.

In step 403, upon receipt of the desired multimedia object data, the multimedia presentation end device presents the desired multimedia object accordingly.

For instance, when the user is in a department store, the mobile end device 32 may receive identification data pieces respectively from a first multimedia end device located in a fashion plaza, a second multimedia end device located in a movie theater, and a third multimedia end device located in a gourmet zone, and their corresponding device names which are exemplified to be “Fashion Plaza”, “Movie Theater” and “Gourmet Zone”, respectively. If the user wishes to present the desired multimedia object using the third multimedia end device that is located in the gourmet zone, the user may operate the mobile end device 32 to select the corresponding identification data piece based on the device name “Gourmet Zone”, thus transmitting the presentation data packet to the server end device 31. The server end device 31 then generates the desired multimedia object data based on the target object data piece included in the presentation data packet, and acquires a target address data piece based on the target identification data piece included in the presentation data packet and a lookup table (see Table 1). Then, the server end device 31 transmits the desired multimedia object data to the third multimedia end device (multimedia presentation end device) based on the target address data piece.

TABLE 1

| Device identification code | IP address |
|---|---|
| WSXCDE2EFGR | 192.168.1.1 |
| QSDEW87ERRQ | 192.168.10.1 |
| 54WDRYUGE56 | 192.168.18.14 |

For example, when the device identification code corresponding to the third multimedia end device is “54WDRYUGE56”, the server end device 31 may transmit the desired multimedia object data to the third multimedia end device of which the IP address is 192.168.18.14 based on the lookup table, so as to cause the third multimedia end device to present the desired multimedia object.

In summary, by virtue of the server end device 11, 31 that generates the desired multimedia object data and transmits the same to the multimedia presentation end device based on the presentation data packet received from the mobile end device 12, 32, it is not required to perform pairing operation between the mobile end device 12, 32 and the multimedia presentation end device, and thus there is no limitation as to the distance between the mobile end device 12, 32 and the multimedia presentation end device.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of presenting a desired multimedia object using a multimedia presentation end device via operation of a mobile end device, said method being implemented by a system that includes a server end device communicatively connected to the multimedia presentation end device and the mobile end device via a first communication network, said method comprising steps of:
(A) receiving, by the server end device from the mobile end device via the first communication network, a target identification data piece that relates to the multimedia presentation end device, and a target object data piece that relates to the desired multimedia object; and
(B) by the server end device, generating, based on the target object data piece, desired multimedia object data that relates to the desired multimedia object, and transmitting, based on the target identification data piece, the desired multimedia object data to the multimedia presentation end device via the first communication network, the desired multimedia object data causing the multimedia presentation end device to present the desired multimedia object.

2. The method of claim 1, wherein the server end device stores a plurality of multimedia end position data pieces that respectively relate to geographic positions of a plurality of multimedia end devices, and a plurality of identification data pieces that respectively correspond to the multimedia end position data pieces, said method further comprising, prior to step (A):
(C) receiving, from the mobile end device via the first communication network, a mobile end position data piece that relates to a geographic position of the mobile end device;
(D) identifying, from the multimedia end position data pieces and based on the mobile end position data piece, at least one candidate multimedia end position data piece that corresponds to at least one of the multimedia end devices of which the geographic position is within a predetermined positional range in relation to the mobile end device; and
(E) acquiring, from the identification data pieces, at least one candidate identification data piece that corresponds to the at least one candidate multimedia end position data piece, and transmitting the at least one candidate identification data piece to the mobile end device via the first communication network, so as to enable the mobile end device to acquire the target identification data piece from the at least one candidate identification data pieces.

3. The method of claim 1, wherein the system further includes the mobile end device, and a plurality of multimedia end devices each having a respective identification data piece, the mobile end device and the multimedia end devices being connected to a second communication network, said method further comprising, prior to step (A):
(C) receiving, by the mobile end device via the second communication network, at least one of the identification data pieces of the multimedia end devices; and
(D) selecting, by the mobile end device, one of the at least one of the identification data pieces to serve as the target identification data piece.

4. The method of claim 1, wherein the server end device stores a plurality of identification data pieces that respectively correspond to a plurality of multimedia end devices, and a plurality of network address data pieces that respectively correspond to the identification data pieces; and
wherein step (B) includes:
acquiring, by the server end device based on the target identification data piece which is one of the identification data pieces, one of the network address data pieces that corresponds to the target identification data piece to serve as a target address data piece; and
transmitting, by the server end device via the first communication network, the desired multimedia object data to the multimedia presentation end device which is one of the multimedia end devices that corresponds to the target address data piece.

5. The method of claim 4, wherein the target address data piece includes one of an Internet Protocol address relating to the multimedia presentation end device, and a media access control address relating to the multimedia presentation end device.

6. The method of claim 1, wherein the target identification data piece includes a target address data piece relating to the multimedia presentation end device, and, in step (B), the server end device transmits the desired multimedia object data via the first communication network to the multimedia presentation end device according to the target address data piece.

7. The method of claim 6, wherein the target address data piece includes one of an Internet Protocol address relating to the multimedia presentation end device, and a media access control address relating to the multimedia presentation end device.

8. The method of claim 1, wherein the server end device stores a plurality of multimedia objects and a plurality object codes respectively corresponding to the multimedia objects, and the target object data piece includes a target object code which is one of the object codes that corresponds to the desired multimedia object which is one of the multimedia objects.

9. The method of claim 1, wherein the target object data piece includes the desired multimedia object.
